(19) United States
(12) Patent Application Publication
(10) Pub. No.: US 2021/0272573 A1
(43) Pub. Date: Sep. 2, 2021

(54) SYSTEM FOR END-TO-END SPEECH SEPARATION USING SQUEEZE AND EXCITATION DILATED CONVOLUTIONAL NEURAL NETWORKS

(71) Applicant: Robert Bosch GmbH, Stuttgart (DE)

(72) Inventors: Midia YOUSEFI, Dallas, TX (US); Pongtep ANGKITITRAKUL, Dublin, CA (US)

(21) Appl. No.: 16/805,716

(22) Filed: Feb. 29, 2020

(51) Int. Cl. G10L 17/00; G10L 17/06; G10L 17/18; G10L 25/84; G06N 3/04; G06N 3/08

(52) U.S. Cl. CPC G10L 17/005; G10L 17/06; G10L 17/18; G06N 3/08; G06N 3/0454; G06N 3/0445; G10L 25/84

(57) ABSTRACT

A voice recognition system includes a microphone configured to receive spoken dialogue commands from a user and environmental noise, a processor in communication with the microphone. The processor is configured to receive one or more spoken dialogue commands and the environmental noise from the microphone and identify the user utilizing a first encoder that includes a first convolutional neural network to output a speaker signature derived from a time domain signal associated with the spoken dialogue commands, output a matrix representative of the environmental noise and the one or more spoken dialogue commands, extract speech data from a mixture of the one or more spoken dialogue commands and the environmental noise utilizing a residual convolution neural network that includes one or more layers and utilizing the speaker signature, and in response to the speech data being associated with the speaker signature, output audio data indicating the spoken dialogue commands.

### TECHNICAL FIELD

The present disclosure relates to voice recognition systems, such as a voice recognition system with single-channel speech separation.

### BACKGROUND

One of the major challenges with voice-control devices (e.g., Apple Siri or Amazon's Alexa) may be to extract the voice command of the target speaker out of interfering speakers (e.g., other users). Most of these systems may be based in the frequency domain. Such systems may utilize a Short-Time Fourier Transform (STFT).

### SUMMARY

According to one embodiment, a voice recognition system includes a microphone configured to receive one or more spoken dialogue commands from a user and environmental noise, a processor in communication with the microphone. The processor is configured to receive one or more spoken dialogue commands and the environmental noise from the microphone and identify the user utilizing a first encoder that includes a first convolutional neural network to output a speaker signature derived from a time domain signal associated with the spoken dialogue commands, output a matrix representative of the environmental noise and the one or more spoken dialogue commands, extract speech data from a mixture of the one or more spoken dialogue commands and the environmental noise utilizing a residual convolution neural network that includes one or more layers and utilizing the speaker signature, and in response to the speech data being associated with the speaker signature, output audio data indicating the spoken dialogue commands.

According to a second embodiment, a voice recognition system includes a controller configured to receive one or more spoken dialogue commands and the environmental noise from the microphone and identify the user utilizing a first encoder that includes a convolutional neural network to output a speaker signature and output a matrix representative of the environmental noise and the one or more spoken dialogue commands, receive a mixture of the one or more spoken dialogue commands and the environmental noise, extract speech data from the mixture utilizing a residual convolution neural network (CNN) that includes one or more layers and utilizing the speaker signature, and in response to the speech data being associated with the speaker signature, output audio data including the spoken dialogue commands.

According to a third embodiment, a voice recognition system includes a computer readable medium storing instructions that, when executed by a processor, cause the processor to receive one or more spoken dialogue commands and the environmental noise from the microphone and identify the user utilizing a first encoder that includes a convolutional neural network to output a speaker signature and output a matrix representative of the environmental noise and the one or more spoken dialogue commands, receive a mixture of the one or more spoken dialogue commands and the environmental noise, extract speech data from the mixture utilizing a residual convolution neural network (CNN) that includes one or more layers and utilizing the speaker signature, and in response to the speech data being associated with the speaker signature, output audio data including the spoken dialogue commands.

### BRIEF DESCRIPTION OF THE DRAWINGS

FIG. 1 shows an example of information dialogue system 100 or voice recognition system.

FIG. 2 discloses a proposed architecture of a voice recognition system according to one embodiment.

FIG. 3 shows a detailed structure of a SE-Dilated CCN in the separator.

FIG. 4 illustrates an example flow chart of the voice recognition system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Single-channel speech separation aims to estimate C individual sources from a linearly mixed signal x(t):

$$x ( t ) = {\sum }_{i = 1}^{C} {s}_{i} ( t )$$

In a typical setup, the mixture x(t) may be transformed to the frequency domain using Short-Time Fourier Transform (STFT) where it is assumed that only the magnitude spectra is available. In such conventional setups, the separation may be carried out using magnitude spectra and the information in the phase spectra which affects the quality of the separated sources may be ignored. Additionally, the transformation of speech signal into the frequency domain and then converting it back to the time domain may introduce distortion to the signal. To avoid degrading the speech signal by domain conversion and also to leverage extra information in the phase spectra, the embodiment disclosed below may be speaker-specific (e.g., user-specific) source estimation in time domain. The mixture and clean sources may be segmented into non-overlapping vectors of L samples. Next, they may be fed into a separation system to train the model.

The system may be an end-to-end, single-channel, target-speaker speech separation system. The system may be based on Dilated CNNs that models the temporal continuity of the speech signal utilizing different receptive fields. However, each kernel in the CNN layers may extract the contextual information based on a local receptive field which is independent of other channels. A Squeeze and Excitation Network (SENet) may be utilized to model the interdependencies between the channels of the convolutional features. This may improve the quality of learnt the speaker-specific representations by recalibrating features using the global information of the data during training. Thus, a reducing in both Signal to Distortion Ratio (SDR) and Scale-Invariant Signal to Noise Ration (SISNR) compared to other systems.

STFT systems may only modify the magnitude response of each speaker and thus leave the phase response unaltered. Second, STFT is a hand-crafted feature with high overlapping consecutive frames which indicates a lot of redundancy in the frequency domain.

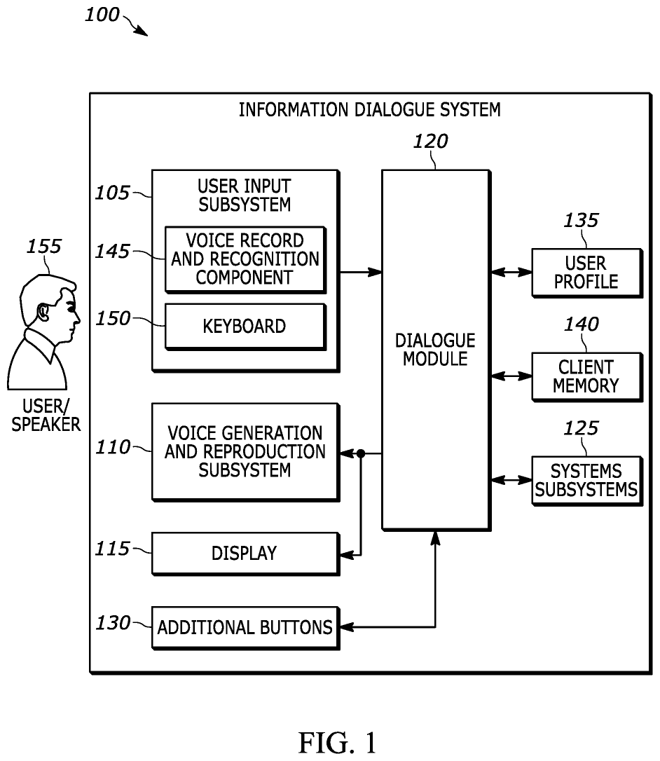

Referring now to the drawings, FIG. 1 shows an example of information dialogue system 100 or voice recognition system. The information dialogue system 100 may include a user input subsystem 105, a voice generation and reproduction subsystem 110, a display 115, a dialogue module 120, additional systems and/or subsystems 125, additional buttons 130, a user profile 135, and a client memory 140. The user input subsystem may include a voice record and recognition component 145 and a keyboard 150. The additional system and/or subsystems may include off-board servers or other remote services.

In an example embodiment, the keyboard 150 and the display 115 may be associated with a user device (not shown). The user device may include mobile devices, such as a laptop, a netbook, a tablet, mobile phones, smartphones, and similar devices, as well as stationary electronic devices, such as computers and similar devices. Furthermore, the voice recognition system 100 may be affiliated with a vehicle multimedia system or any other similar computing device.

The additional buttons 130 may include physical buttons of the user device and soft keys of the information dialogue system 100. For example, pressing of the “Microphone” soft key by the user may activate or disable a voice record and recognition component 145, pressing of the “Cancel” soft key may cancel the current operation performed by the information dialogue system 100, and so forth. The additional systems and/or subsystems 125 in the context of the present disclosure may include systems for working with functions of the user devices, such as a global positioning system. In addition, the voice recognition system 100 may activate a voice recognition session based on utilization of a “wake word.”

The user profile 135 may include an account that contains settings, preferences, instructions, and user information. The client memory 140 may store information about a user 155 that interacts with the information dialogue system 100. The speaker 155 may initiate various interaction between the components of the information dialogue system 100. For example, activation of a user input subsystem 105 based on a user request; entering of a training request by the user 155; and receiving and converting the training request of the user 155 into the text by the user input subsystem 105. Additionally, the sending of the text of the training request received as a result of conversion to a dialogue module 120, followed by processing of the received text by the dialogue module 120 and forming of a response to the training request by the dialogue module 120; sending of the response to the training request to the user 155; displaying of the response to the training request in the form of the text on a display 115; reproduction of the response to the training request in the form of a voice cue by a voice generation and reproduction subsystem 110, followed by an automatic activation of the user input subsystem 105; pressing of additional buttons 130 by the user 155 (for example, disabling the voice record and recognition component 145); performing of the actions corresponding to the additional buttons 130; interaction with additional systems and/or subsystems 125 (sending of the request to the additional systems and/or the subsystem 125 by the dialogue module 120, processing of the received request by the additional systems and/or the subsystems 125, sending of a result to the dialogue module 120); interaction with a user profile 135 (sending of the request by the dialogue module 120, receiving information from the user profile 135); and interaction with a client memory 140.

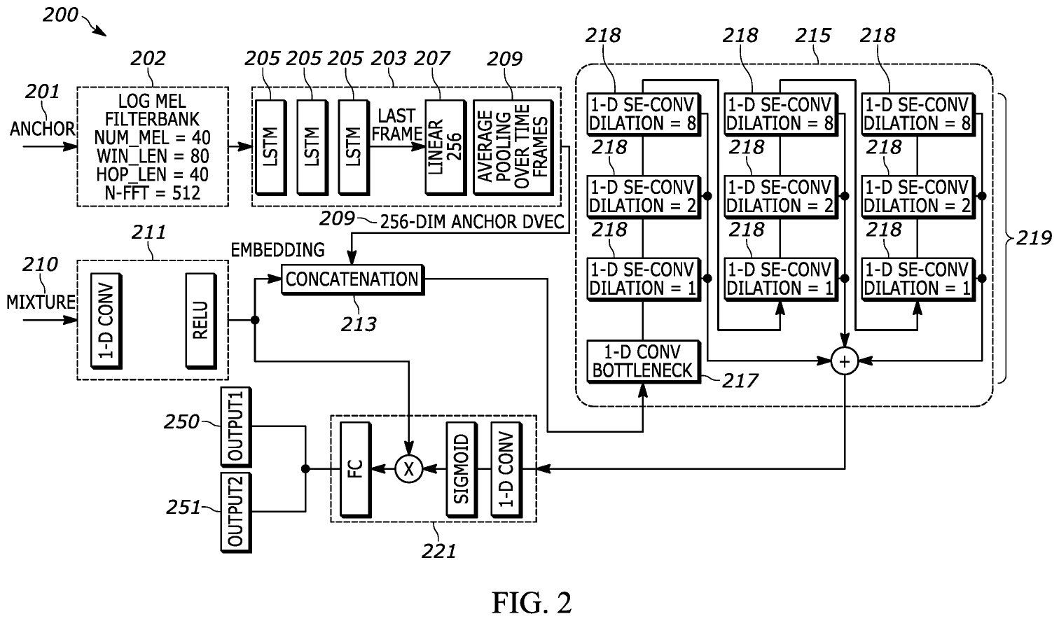

FIG. 2 discloses a proposed architecture 200 of a voice recognition system according to one embodiment. Shows a proposed architecture that includes a speaker recognition system that extracts d-vector embedding based on an anchor word 201 input into a voice recognition system, such as one described above in FIG. 1. The system also includes an encoder to learn the mixture embedding, a separator to estimate individual sources and finally a decoder for waveform reconstruction.

The wake word 201 may be a time domain speech signal, also known as a waveform. The time domain waveform may be converted to a compact feature utilizing the filter bank 202. The filter bank 202 may extract the main structure of the speech signal. A vector component (e.g., d-vector) may be configured to determine feature vectors of the audio segments. The vector component may allow the system to identify different attributes of the speech signal, such as the gender of the speaker, age range, a personal identity, etc. The feature vectors may include a first feature vector of the first audio segment and/or other feature vector(s) of other audio segment(s). The feature vectors may be determined based on application of one or more Mel filter bank 202 to the audio segments/representations of audio segments. The Mel filter bank 202 may be applied to the audio segments/representations of audio segments to determine feature vectors. A Mel filter bank 202 may be expanded or contracted, and/or scaled based on a sampling rate of the audio content. The expansion/contraction and scaling of the Mel filter bank 202 may account for different sampling rate of the audio content. For example, a Mel filter bank 202 may be sized for application to audio content with sampling rate 44.1 kHz. If audio content to be analyzed for voice is of different sampling rate, the size of the Mel filter bank 202 may be adapted (expanded/contracted and scaled) to account for the difference in sampling rate. Dilation coefficient may be given by the sampling rate of the audio content divided by the reference sampling rate. Such adaption of the Mel filter bank 202 may provide for audio segment feature vector extraction that is independent of the audio content sampling rate. That is, the adaptation of the Mel filter bank 202 may provide for flexibility in extracting feature vectors of audio content with different sampling rates. Different sampling rates may be accounted for via transformation in the frequency domain rather than in the time domain, allowing for removing of features as if they were extracted at the sampling rate of reference.

A speaker encoder 203 may be utilized to take the output of the Mel filter bank 202, e.g. a matrix component. The speaker encoder 203 may include a long short-term memory (LSTM) network 205. The speaker encoder 203 may learn the speaker embedding based on the anchor word 201 or wake word 201, which may be utilized to recognize the identify of the target speaker through his voice. The speaker encoder 203 may be a three-layer LSTM network in which the last time step of the final layer is fed into a linear feed forward layer for dimension conversion. Thus to prepare the input of speaker encoder 203 the Log Mel 202 may extract the log-mel filterbank based on the anchor word 201, and then perform sliding windows with 50% overlap (or another amount) on top of it. The output of the speaker encoder 203 may be a fixed-length vector of 256 dimensions, sometimes called a d-vector 209, which is an average of the L2-normalized d-vector obtained on each window. Thus, the speaker encoder may utilize the wake word in waveform and generate a vector component (e.g., signature or identifier of the speaker). Each of the LSTM network layers 205 perform mathematical operations to the vector components that were extracted from the feature bank. Each of the outputs from the layers 205 is provided as input to the next layer 205. This may allow extraction of high-level information in the feature vector. The LSTM at the final output may capture the last moment of the speech signal that has all the information needed into the audio to identify the key features. The LSTM may allow the features to be identified from that last frame and allow the key features to be identified by that frame. The last frame may be a high-dimensional feature that includes a high sample rate (e.g., 500 samples) and is thus fed into the Linear 256 Layer 207 to reduce computational cost. Thus, the last frame may be fed into a linear 256 fully connected layer to obtain a 256 dimensional signatures based on the anchor. The output of the 256 layer may include 256 samples that is an identity or user-specific feature for that target speaker, and thus identify such characterizes. A pooling layer 208 may take an average pooling over time frames of the output from the 256 layer 207. The pooling layer 208 may make the system robust by deriving multiple d-vectors by averaging all the d-vectors from the speech signal that is extracted. Thus, the pooling may help provide robustness and prevent duplication of such speech signal.

A speech encoder 211 may be utilized to learn an embedding for the mixture signal 210 based on a speech waveform. The mixture signal 210 may contain the speech signal of the user, background noise, or other speakers that are not intending to utilize the voice recognition system. Because the separation is performed in time domain, the speech encoder 211 may be used to learn an embedding for the mixture signal 210 based on speech waveform. Using the features learned by the encoder may provide advances over a conventional STFT. First, the STFT may be manually designed and may not be the best representation for a separation task (e.g., separating a “wake word” 201 or the user spoken dialogue from background noise). Second, the phase information may be neglected in the STFT-based systems. Third, a higher resolution STFT may be desired, which may be achieved by using a longer window of time-domain waveform, which introduces a considerable latency in the system. For example, if a 512 dimension STFT with sampling frequency fo 16 kH is used, the time delay is 32 ms, while using a 40 dimension segmentation for the time domain signal with the same sampling frequency introduces only 2.5 ms latency making it suitable for real time systems, such as hearing aids. The speech encoder may include a convolution layer followed by a Rectified linear Unit (ReLU) activation function to guarantee non-negatively of the extracted embedding:

X=ReLU(xₖ [symbol] W) k=1,2, . . . K

A concatenation module 213 or component may be utilized to aggregate the data output by the speech encoder 211 and the speaker encoder 205. The concatenation component 213 may be utilized to provide input to the separator 215. A d-vector component may be concatenated to all the time steps of the speech embedding. At the concatenation module 213 may add the d-vector/signatures to every speech signal captured in the environment, as collected from the speech encoder. If the signature derived from the wake word 201 finds a match from the other speech signal's signatures (e.g. other speakers or mixtures signatures), the system may be able to identify the other speech signal's as commands or other related information as pertaining to a voice recognition session. If there is no match, the system may assume that the other speech signal is simply background noise not pertaining to the voice recognition session.

At the separator module or component 215, a bottleneck of one-dimensional convolution layer 217 may be used as a non-linear dimension reduction in order to decrease the computation cost. Thus, the one-dimensional convolution layer 217 may be a layer in a CNN that contains few nodes compared to other layers. The bottleneck layer 217 can be used to obtain a representation of the input with reduced dimensionality. The input of the bottleneck convolutional layer 217 may be 256 dimensional features which after apply the bottleneck layer to dimension may be reduced to 128. An example may include the use of autoencoders with bottleneck layers for nonlinear dimensionality reduction. The bottle neck 217 may reduce the 256-dimensional feature component to 128 dimensions, in one example.

The speech separator 215 may take into account both the user signature vector and the spoken dialogue mixed with the background noise (e.g., the output of the speech encoder), based on the identity (signature) vector of the speaker, the separator may extract the speech belonging to the target user interacting with the voice recognition system. The speech separator 215 may generate two masks, one for estimating the speech signal belonging to the target user and the other one to extract the environmental noise or the speech of interfering talkers. The speech separator 215 may generate and/or passes the estimated masks into the decoder, where the spoken dialogue belonging to the target user is extracted from the environmental noise and other interfering talkers.

After the bottleneck layer 217 outputs a representation that is reduced (e.g., the output is the compact representation of the input). For example, if the input of the bottleneck layer 217 is a 256 dimension vector, the bottleneck layer 217 maps this feature vector into a new feature vector with a size of 128 dimensions that has the same information content as the 256 dimension feature vector A stack of F SE-Dilated CNN residual blocks 218 with different dilation factors are repeated R times. For example, one layer 219 in the CNN may include a dilation factor of 1, two, and then 8. Each CNN residual block 218 learns a feature map for the input signal based on a local receptive filed. The size for the receptive directly affects the quality and resolution of the learned feature map. The size of the receptive field depends on the dilation factor. Therefore, several CNN residual blocks 218 may be used to assure that the learned features in each block 218 are capturing information different from receptive filed with various resolutions. In order to model the temporal continuity of speech signal using CNN, a large receptive field may be utilized. Two possible methods of increasing the receptive field are either increasing the network depth and using dilated CNN. Increasing network depth may result in output degradation, therefore residual learning may be used to build a deeper network in order to increase the receptive filed without decreasing the performance. Additionally, dilated convolution may be used which increases the receptive field without decreasing the output resolution:

$$( A {r}_{} B ) = {\sum }_{j + ri = p} A ( j ) B ( i )$$

Where A and B are convoluted signals and r is the dilation factor. In the equation above, r sample gaps are defined per input and if r is set to one, the conventional convolution may be performed. For r greater than or equal to 1 the receptive field may be increased exponentially with out of loss coverage.

A speech decoder 221 may be utilized to transfer the estimated speaker-specific sources back to the time domain waveform. The decoder may take the output out of the separator and pass it through a convolutional layer followed by a sigmoid function to estimate the source-specific masks:

M=Sigmoid(Z [symbol] U)

Z is the output of the separator and U is the weight of the convolution layer. The estimated masks may then be multiplied by the mixture embedding to separate the target speech from the mixture. Next, a fully connected layer may be used to convert the dimension of the estimated sources to L which is the size of the mixture embedding segments.

The output from the decoder 221 may include a target speaker output 250 and an interferer output 251. The target speaker output 250 may include voice commands or responses related to the voice recognition system. The interferer output 251 may include any background noise or speech that is not related to or derived from the target speaker.

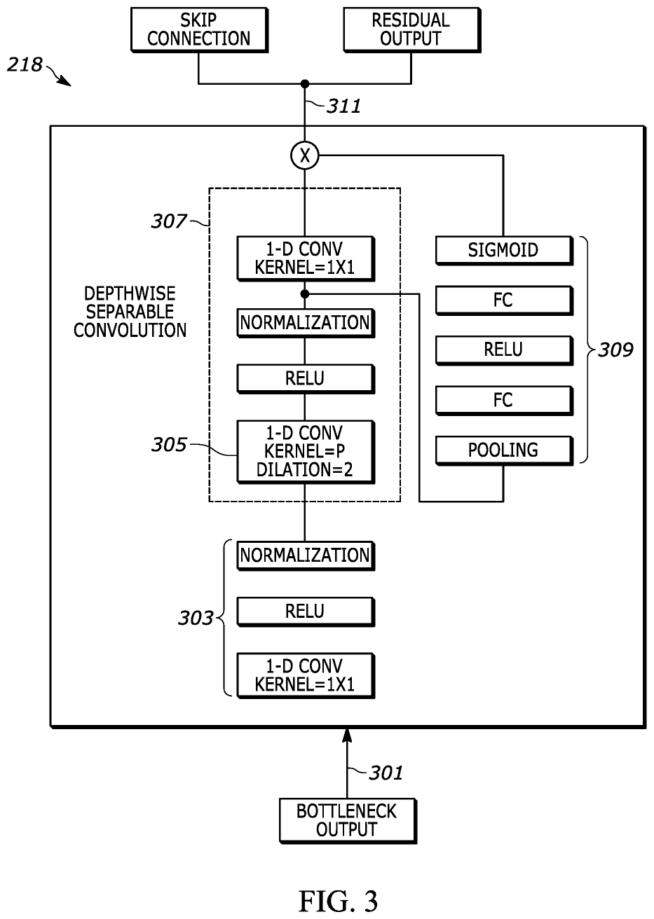

FIG. 3 shows a detailed structure of a SE-Dilated CCN in the separator. The output 301 from the bottleneck may enter into the CNN residual block 218. The input of the residual block (e.g., the input of the first CNN residual block is the output of the bottleneck, and the input to the remaining residual blocks 218 is the output of the previous residual block. Within each residual block 218, the input may be fed into a series of operation specified as 1-d convolutional layer, a relu activation function and a normalization step. These series of operations are depicted as 303 in FIG. 3. Next, the normalized output is passed to a depth wise separable convolution layer 307. The depth wise separable convolution layer 307 includes one 1-d convolutional layer with dilation 2 305 followed by a relu activation function and a normalization step. In this step, the output is passed into two different processing steps. One is the 1-d convolution layer and the other one is teh block 309 in FIG. 3 called the Squeeze and Excitation Network. The Squeeze and Excitation Network 309 includes a pooling layer which averages the features and pass them to two fully connected layers with a relu activation function in between. Eventually by applying a sigmoid activation function, a vector of weights is derived which are used to scale the final output of the CNN residual block 281. In other words, the weights generated by 309 amplify the useful extracted information and suppress the less important ones in the final output block 219. The depth wise separable convolution layer may take in an input from the bottle neck output. The squeeze and excitation network (SENet) may be layer performed over the CNN in order to improve the channel interdependencies at almost no or very little computational cost. Different filters in CNN may find distinct contextual information over time dimension based on a specific receptive field. Thus, they may be unable to exploit the information outside this region. The issue may become more challenging in the initial layers due to the small receptive field. To alleviate such issues, the SE layer first descriptor may be using a global average pooling. In other words, every output channel may be average into a neuron which can be seen as a brief description of that channel. Afterwards, each channel descriptors may be fed into two fully connected layers 305, 309 with ReLU and sigmoid activation functions. The outputs may be channel-specific weights that have captured the channel-wise dependencies and are used to recalibrate the extracted contextual information in each output channel. Finally, the output of the CNN residual block 218 is passed to both the next residual block 218 and the summation sign shown in block 215 as the final output of the separator block 215. These outputs are the same, but they are named differently based on the next step they are passed to. The skip connection output is passed to the next residual block 218, and the residual output is passed to the summation sign 215.

A depth-wise separable CNNs may be utilized to factorize the standard convolution into two steps. The first step may be a depth-wise convolution and a 1×1 point-wise convolution. In such a proposed method, depth-wise convolution applies a single filter to each input channel, then the output of the depth-wise convolution may be combined by a 1×1 convolution performed by the point-wise convolution. A standard convolution with a kernel size of E×Q×Z may be factorized into two convolution with kernel sizes of E×Q and E×Z, therefore the number of parameters may be reduced by a factor of Q if Q>=Z:

$$\frac{E \times Q \times Z}{E \times Q + E \times Z} \approx Q$$

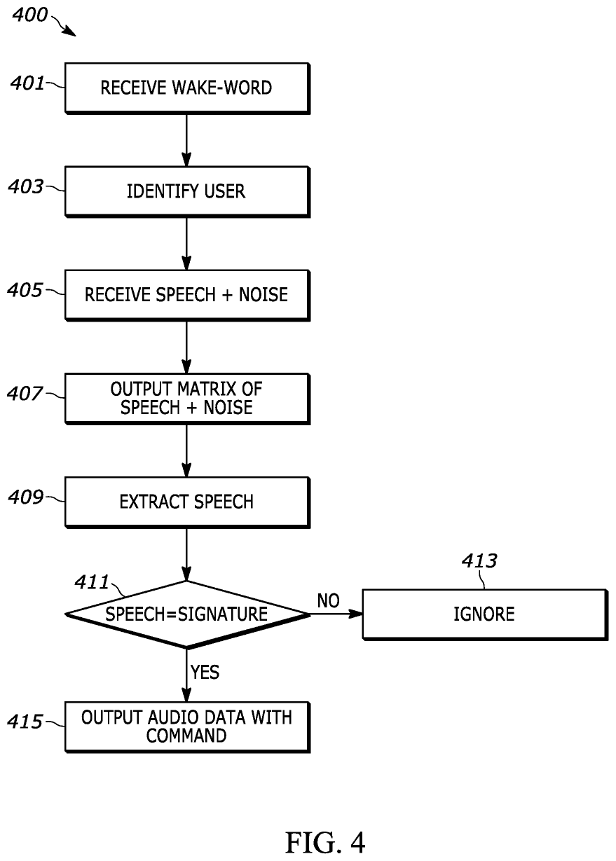

FIG. 4 includes a flowchart 400 describing the voice recognition system above. At step 401, the system may receive a wake word from one or more users. In this step, the user may wake up the smart device with an anchor word or wake word such as “Hey SIRI.” The microphone of the device may capture the anchor word. At step 403, the speaker encoder may activate to derive a signature for the user that wakes up the device. As described above, the signature may be utilized to identify the user. The signature may identity the user during initiation or initial use of the voice recognition command (e.g., when the voice recognition initializes and asks the user to repeat certain commands).

At step 405, the system may attempt to retrieve the spoken command after the wake word initializes the voice recognition system. However, there may be interfering talkers or environmental noise, such as music, the sound of a car passing by, an interfering talker, etc. The microphone may thus capture a speech signal that contains not only the spoken voice command, but other background noise. As discussed in detail below, the system will attempt to extract the spoken voice command from the other noise utilizing the signature. The signature is a 256 dimensional vector that contains the characteristics of the user's voice. Therefore, the voice recognition system may be used to extract the spoken dialogue captured by the microphone that has the same characteristics as the signature out of the environmental noise and interfering talkers.

At step 407, the system may output a matrix from the speech encoder. This Matrix may be the learned representation for the time domain mixture waveform by the speech encoder. As previously mentioned, the mixture may contain all the active sounds in the location of the VR system, such as environmental noise as well as noise from a TV, music playing, and interfering talkers, etc. Then, the derived signature may concatenated to this matrix to provide information about the identity and characteristics of the target user into the separator block 215 in FIG. 2. Then the matrix (which includes the learned representation of the sound captured by the microphone and also the signature) may be fed into the separator.

At step 409, the separator may try to separate the speech commands that belongs to the same speaker that has woken up the smart device. Thus, the separator may attempt to match the characteristics and attributes identified in the speech commands with those of the signature. Because the signature is derived for a specific person that wakes up the device (e.g., the person has said the wake word), the system can identify his/her voice with the spoken command. This may be accomplished by comparing the characteristics of each segment of the recorded speech found in the matrix with the signature that is stored in memory. As an example, if a random talker in the location of the voice recognition system interferes with the user of the voice recognition system, the separator block may attempt to separate the spoken dialog belonging to the user in the output and discard those environmental noises and spoken dialogs from interfering talkers.

At decision 411, the system may determine whether the speech commands match the signature. If the speech commands and the signature do not match, meaning that the speech commands were not derived from the user that activated the voice recognition system via the wake word, the system may simply ignore the speech commands (which may be environmental noise) at step 413. However, the speech commands do match the signature, the system may output audio data or another output at step 415. The audio data that is output may include a WAV file or another type of sound file that repeats the command that was spoken into by the target user. The audio data may be able to remove any of the environmental noise so that only the spoken command is heard during playback. Furthermore, the audio data may also mitigate any of the environmental noise so that is not as pronounce. In addition, the system may output text via speech-to-text to be displayed on the smart device.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A voice recognition system, comprising:
a microphone configured to receive one or more spoken dialogue commands from a user and environmental noise; and
a processor in communication with the microphone, wherein the processor is configured to:
receive one or more spoken dialogue commands and the environmental noise from the microphone and identify the user utilizing a first encoder that includes a first convolutional neural network to output a speaker signature derived from a time domain signal associated with the spoken dialogue commands;
output a matrix representative of the environmental noise and the one or more spoken dialogue commands;
extract speech data from a mixture of the one or more spoken dialogue commands and the environmental noise utilizing a residual convolution neural network that includes one or more layers and utilizing the speaker signature; and
in response to the speech data being associated with the speaker signature, output audio data indicating the spoken dialogue commands.

2. The voice recognition system of claim 1, wherein the audio data indicating the spoken dialogue commands contains no environmental noise.

3. The voice recognition system of claim 1, wherein the audio data indicating the spoken dialogue commands contains mitigated environmental noise.

4. The voice recognition system of claim 1, wherein the first encoder includes a multi-layer long short-term memory network.

5. The voice recognition system of claim 1, wherein the audio data includes the spoken dialogue commands.

6. The voice recognition system of claim 1, wherein the residual convolution neural network includes multiple layers.

7. The voice recognition system of claim 6, wherein the one or more layers of the residual convolution neural network includes two or more dilation segments.

8. The voice recognition system of claim 7, wherein the two or more dilation segments include different time periods.

9. The voice recognition system of claim 1, wherein the processor is further configured to ignore the speech data when it is not associated with the speaker signature.

10. A voice recognition system, comprising:
a controller configured to:
receive one or more spoken dialogue commands and environmental noise from a microphone and identify a user utilizing a first encoder that includes a convolutional neural network to output a speaker signature and output a matrix representative of the environmental noise and the one or more spoken dialogue commands;
receive a mixture that includes the one or more spoken dialogue commands and the environmental noise;
extract speech data from the mixture utilizing a residual convolution neural network (CNN) that includes one or more layers and utilizing the speaker signature; and
in response to the speech data being associated with the speaker signature, output audio data including the spoken dialogue commands.

11. The voice recognition system of claim 10, wherein the audio data indicating the spoken dialogue commands contains no environmental noise.

12. The voice recognition system of claim 10, wherein the audio data indicating the spoken dialogue commands contains mitigated environmental noise.

13. The voice recognition system of claim 10, wherein the speaker signature is derived from a time domain signal associated with the spoken dialogue commands.

14. The voice recognition system of claim 10, wherein the voice recognition system is a smart speaker.

15. The voice recognition system of claim 10, wherein the voice recognition system is a vehicle multimedia system.

16. A voice recognition system comprising:
a computer readable medium storing instructions that, when executed by a processor, cause the processor to:
receive one or more spoken dialogue commands and environmental noise from a microphone and identify a user utilizing a first encoder that includes a convolutional neural network to output a speaker signature and output a matrix representative of the environmental noise and the one or more spoken dialogue commands;
extract speech data from a mixture including the environmental noise and one or more spoken dialogue commands utilizing a residual convolution neural network (CNN) that includes one or more layers and utilizing the speaker signature; and
in response to the speech data being associated with the speaker signature, output audio data including the spoken dialogue commands.

17. The voice recognition system of claim 16, wherein the audio data indicating the spoken dialogue commands contains no environmental noise.

18. The voice recognition system of claim 16, wherein the audio data indicating the spoken dialogue commands contains mitigated environmental noise.

19. The voice recognition system of claim 16, wherein the speaker signature is derived from a time domain signal associated with the spoken dialogue commands.

20. The voice recognition system of claim 16, wherein the voice recognition system is a smart speaker.
